(19) United States
(12) Patent Application Publication
(10) Pub. No.: US 2023/0037904 A1
(43) Pub. Date: Feb. 9, 2023

(54) MODEL COMPRESSION DEVICE, MODEL COMPRESSION METHOD, AND PROGRAM RECORDING MEDIUM

(71) Applicant: NEC Corporation, Minato-ku, Tokyo (JP)

(72) Inventor: Masato YUKI, Tokyo (JP)

(73) Assignee: NEC Corporation, Minato-ku, Tokyo (JP)

(21) Appl. No.: 17/788,069

(22) PCT Filed: Dec. 26, 2019
(86) PCT No.: PCT/JP2019/051276

§ 371 Date: Jun. 22, 2022

(51) Int. Cl. G06N 3/04; G06K 9/62

(52) U.S. Cl. CPC G06N 3/0454; G06K 9/6262

(57) ABSTRACT

A model compression device includes a compression unit and a determination unit. The compression unit is configured to create a compression model arrived at by compressing a first prediction model created by machine learning. The determination unit is configured to determine whether or not a second prediction model created by re-learning the compression model can be further compressed on the basis of an index related to the performance of the second prediction model.

### TECHNICAL FIELD

The present invention relates to a model compression device or the like that compresses a prediction model.

### BACKGROUND ART

By deepening the network structure of a neural network (NN: Neural Network), the accuracy of a learned prediction model can be improved. However, as the network structure of the NN is deepened, the time (hereinafter, referred to as a prediction time) of the prediction phase using the prediction model including the NN becomes longer. By compressing the data size of the prediction model, the prediction time can be shortened. However, if the data size of the prediction model is excessively compressed, the prediction accuracy is excessively reduced, and a problem may occur in actual operation.

PTL 1 discloses an NN structure optimization device that optimizes a network structure in any layer of a hierarchical NN. The device of PTL 1 changes the structure of the NN based on the importance of each neuron of the hierarchical NN. The device of PTL 1 calculates an evaluation value of an NN relearned for an NN whose structure has been changed, and repeats changing the structure of the NN and relearning for the NN whose structure has been changed until the calculated evaluation value is below a reference evaluation value.

PTL 2 discloses a method for optimizing a structure of an NN. In the method of PTL 2, a second NN is generated by randomly deleting units from a first NN, the cost of the first NN is compared with the cost of the second NN, and an NN with a smaller cost is set as the first NN. In the method of PTL 2, when an event in which the cost of the first NN is larger than the cost of the second NN continuously occurs a predetermined number of times, the first NN at the learning end time point is output as the optimal structure.

NPLs 1 to 4 disclose a technique for visualizing a feature portion detected from verification data when the verification data is verified by an NN.

### Citation List

### Patent Literature

[PTL 1] JP 9-091264 A
[PTL 2] JP 2015 011510 A

### Non Patent Literature

[NPL 1] R. Selvaraju, et al., “Grad-CAM: Visual Explanations from Deep Networks via Gradient-based Localization”, arXiv:1610.02391v3 [cs.CV] 21 Mar. 2017.
[NPL 2] D. Smilkov, et al., “SmoothGrad: removing noise by adding noise”, arXiv:1706.03825v1 [cs.LG] 12 Jun. 2017.
[NPL 3] F. Wang, et al., “Residual Attention Network for Image Classification”, arXiv:1704.06904v1 [cs.CV] 23 Apr. 2017.
[NPL 4] J. Hu, et al., “Squeeze-and-Excitation Networks”, arXiv: 1709.01507v4 [cs.CV] 16 May 2019.

### SUMMARY OF INVENTION

### Technical Problem

The device of PTL 1 can compress the prediction model by repeating removal of neurons from the NN and learning using the NN from which neurons have been removed. However, in the device of PTL 1, since the neurons to be removed are set based on the importance, in a case where there are a plurality of neurons having the same degree of importance, there is a possibility that the network structure of the NN is excessively compressed and the generalization performance of the prediction model is excessively deteriorated.

The device of PTL 2 repeats generating a second NN by randomly deleting units from the first NN and updating the first NN based on the cost. Therefore, the device of PTL 2 has a problem that it takes time to optimize the structure of the NN because the first NN is repeatedly updated based on the cost after the NN is randomly compressed.

An object of the present invention is to provide a model compression device and the like capable of efficiently generating a prediction model whose prediction time is shortened while ensuring adequate generalization performance required for machine learning.

### Solution to Problem

A model compression device according to an aspect of the present invention includes: a compression unit configured to generate a compression model obtained by compressing a first prediction model generated by machine learning; and a determination unit configured to determine whether a second prediction model can be further compressed based on an index related to performance of the second prediction model generated by relearning the compression model.

In a model compression method according to an aspect of the present invention, a computer executes: compressing a first prediction model generated by machine learning in a learning device to generate a first compression model; performing relearning on the learning device in the first compression model; determining whether a second prediction model generated by the machine learning satisfies a predetermined index related to generalization performance; and compressing the second prediction model to generate a second compression model when the predetermined index is satisfied.

A program according to an aspect of the present invention causes a computer to execute processes of: compressing a first prediction model generated by machine learning in a learning device to generate a first compression model; performing relearning on the learning device in the first compression model; determining whether a second prediction model generated by the machine learning satisfies a predetermined index related to generalization performance; and compressing the second prediction model to generate a second compression model when the predetermined index is satisfied.

### ADVANTAGEOUS EFFECTS OF INVENTION

According to the present invention, it is possible to provide a model compression device and the like capable of efficiently generating a prediction model whose prediction time is shortened while ensuring adequate generalization performance required for machine learning.

### BRIEF DESCRIPTION OF DRAWINGS

FIG. 1 is a block diagram illustrating an example of a configuration of a learning system according to a first example embodiment.

FIG. 2 is a conceptual diagram illustrating an example of a neural network included in a prediction model compressed by a compression unit of the learning system according to the first example embodiment.

FIG. 3 is a conceptual diagram illustrating another example of a neural network included in a prediction model compressed by a compression unit of the learning system according to the first example embodiment.

FIG. 4 is a block diagram illustrating an example of a configuration of a determination unit included in the learning system according to the first example embodiment.

FIG. 5 is a block diagram illustrating an example of a configuration of a determination unit included in the learning system according to the first example embodiment.

FIG. 6 is a conceptual diagram illustrating an example of a visualization map generated by a visualization unit of a determination unit included in the learning system according to the first example embodiment.

FIG. 7 is a conceptual diagram illustrating another example of a visualization map generated by a visualization unit of a determination unit included in the learning system according to the first example embodiment.

FIG. 8 is a flowchart for explaining an example of an operation of the learning system according to the first example embodiment.

FIG. 9 is a flowchart for explaining another example of the operation of the learning system according to the first example embodiment.

FIG. 10 is a block diagram illustrating an example of a configuration of a model compression device according to a second example embodiment.

FIG. 11 is a block diagram illustrating an example of a hardware configuration for achieving the learning system (including the model compression device according to the second example embodiment) according to the first example embodiment.

### EXAMPLE EMBODIMENT

Hereinafter, example embodiments of the present invention will be described with reference to the drawings. In all the drawings used in the following description of the example embodiment, the same reference numerals are given to the same parts unless otherwise specified.

Further, in the following example embodiments, repeated description of similar configurations and operations may be omitted. The direction of the arrow in the drawings is an example, and the direction of the signal between the blocks and the like are not limited to the direction of the arrow.

### First Example Embodiment

First, a learning system according to a first example embodiment of the present invention will be described with reference to the drawings. The learning system of the present example embodiment includes a model compression device that compresses a prediction model including a neural network (hereinafter, referred to as NN). The model compression device included in the learning system of the present example embodiment generates a prediction model capable of shortening a prediction time while ensuring adequate prediction accuracy required for machine learning. Hereinafter, the prediction model before compression is also referred to as a first prediction model, and the prediction model after compression is also referred to as a second prediction model.

In the first example embodiment, the model compression device compresses the prediction model of the NN generated by machine learning in the learning device by, for example, pruning processing. The pruning is to disconnect a part of an edge connecting a plurality of neurons constituting the NN, that is, to eliminate data transfer between specific nodes. The model compression device causes the learning device to execute relearning again with the compressed prediction model. Next, the model compression device determines whether the compressed prediction model can be further compressed based on whether the relearned prediction model satisfies a predetermined index related to performance. One or more indexes are used for the determination. When it is determined that the prediction model can be compressed by the determination, the model compression device compresses the prediction model again and performs relearning. This compression and relearning process is repeatedly executed while it is determined that compression is possible. As a result, a prediction model capable of shortening the prediction time while ensuring adequate performance is generated.

### Configuration

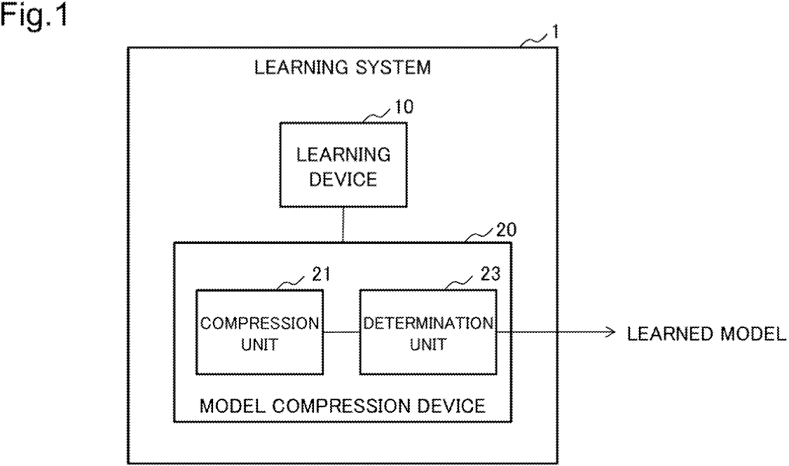

First, a configuration of a learning system according to the present example embodiment will be described with reference to the drawings. FIG. 1 is a block diagram for explaining an example of a configuration of a learning system 1 of the present example embodiment. The learning system 1 includes a learning device 10 and a model compression device 20. Note that the learning device 11 and the model compression device 20 may be configured in the same device or may be configured in different devices. For example, the learning device 10 and the model compression device 20 are configured as the same server or terminal device. For example, one of the learning device 10 and the model compression device 20 may be configured as a server, and the other may be configured as a terminal device.

### Learning Device

The learning device 10 generates a prediction model of a neural network (NN) that receives training data as an input and outputs a classification result (also referred to as an identification result) of a predetermined category by learning. The training data includes a data set including data of image data, text data, or time-series data and data of a correct answer label indicating a classification category of each data. In the present example embodiment, the training data is also referred to as learning data.

The NN generated as the prediction model has structures such as a perceptron, a convolutional neural network, a recursive neural network, and a residual network. For example, the NN can use a convolutional neural network (CNN) having image data, text data, or time series data as input data.

In a case where the data included in the training data is image data, the learning device 10 inputs the pixel value of the pixel constituting the image data to the prediction model, and optimizes the weight of each edge included in the compression model so that the degree of being classified into the category related to the correct answer label increases. When the data included in the training data is text data, the learning device 10 inputs elements such as words, idioms, and phrases constituting the text data to the prediction model, and optimizes the weight of each edge included in the compression model so that the degree of outputting the correct answer increases. In a case where the data included in the training data is time-series data, the learning device 10 inputs elements such as waveforms and data values constituting the time-series data to the prediction model, and optimizes the weight of each edge included in the compression model so that the degree of being classified into the category related to the correct answer label increases.

The learning device 10 optimizes the weight of each edge using a stochastic gradient method, a mini-batch method, a batch method, an error back propagation method, or the like. The learning device 10 may optimize the activation function of each layer constituting the NN. Note that the method of adjusting the compression model by the learning device 10 is not limited to the method described herein.

### Model Compression Device

As illustrated in FIG. 1, the model compression device 20 includes a compression unit 21 and a determination unit 23.

The compression unit 21 acquires a prediction model from the learning device 10. In the prediction model, a model that is not compressed by the compression unit 21 is referred to as a first prediction model in the present example embodiment. The compression unit 21 compresses the first prediction model of the NN generated by the machine learning in the learning device 10 by, for example, pruning. The compression unit 21 causes the learning device 10 to perform machine learning (relearning) again with the compressed first prediction model (hereinafter, also referred to as a compression model).

The determination unit 23 analyzes whether the relearned prediction model satisfies a predetermined index related to performance. The relearned prediction model is referred to as a second prediction model in the present example embodiment. When it is determined by the analysis that the performance satisfies the predetermined index, the determination unit 23 instructs the compression unit 21 to perform recompression and relearning for the second prediction model. The recompression by the compression unit 21 and the relearning by the learning device 10 are repeated until it is determined by the analysis that a predetermined index related to performance is not satisfied.

Next, the compression of the prediction model by the compression unit 21 will be described in more detail. Compression of the prediction model is performed for the purpose of shortening a classification time (also referred to as a prediction time) by the prediction model. As described above, the compression of the prediction model and the relearning of the prediction model after the compression are repeated until the determination unit 23 determines that the predetermined index related to the generalization performance of the machine learning by the prediction model is not satisfied in the determination using the index described later.

In the compression unit 21, the compression amount of the prediction model is set to be constant at a stage of repeating compression as described later. However, for example, the compression amount is set to such an extent that the prediction model is not compressed too much as the performance of the prediction model is affected only by the compression of the first prediction model (that is, only one compression). The compression unit 121 may change the compression amount of the prediction model by the compression unit 21 in the process of repeating the compression instead of being constant.

The compression unit 21 compresses the prediction model by disconnecting ting off an edge connecting nodes. For example, the compression unit 21 compresses the prediction model by disconnecting at least any one of the edges included in the NN included in the prediction model based on a preset condition. Cutting an edge included in the NN corresponds to sorting edges necessary for extracting a feature from input data (blocking input of data to a disconnection destination node).

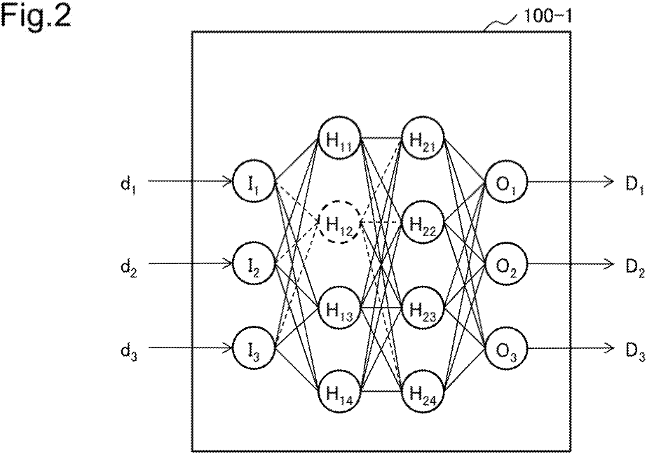

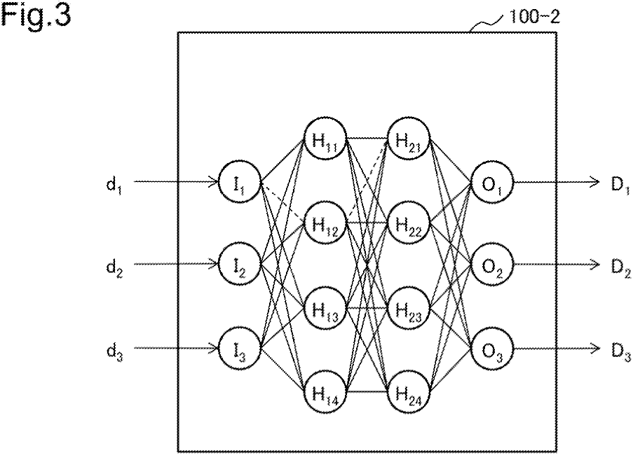

Next, an example of disconnecting an edge connecting nodes will be described in detail with reference to FIGS. 2 and 3.

An NN 100-1 illustrated in FIG. 2 is an example (first compression example) of an NN included in the prediction model compressed by the compression unit 21. The input layer includes three nodes (I₁, I₂, I₃) to which input data (d₁, d₂, d₃) is input. The intermediate layer includes a first intermediate layer including four nodes (H₁₁, H₁₂, H₁₃, H₁₄) and a second intermediate layer including four nodes (H₂₁, H₂₂, H₂₃, H₂₄). The output layer includes three nodes (O₁, O₂, O₃) that convert information from the second intermediate layer into prediction values (D₁, D₂, D₃). In FIG. 2, a line connecting nodes is an edge.

In the case of the first compression example illustrated in FIG. 2, after the compression, all the edges of the NN 100-1 connected to the node H₁₂ of the first intermediate layer are disconnected. That is, the NN 100-1 is an example of disconnecting off all the edges connected to at least one node of the NN after compression, and substantially corresponds to deletion of the node H₁₂. In the example of FIG. 2, the node H₁₂ is not used.

An NN 100-2 illustrated in FIG. 3 is an example (second compression example) of an NN included in the prediction model compressed by the compression unit 21. The NN 100-2 is an example in which an edge connected between the node I₁ of the input layer and the node H₁₂ of the first intermediate layer and an edge connected between the node H₁₂ of the first intermediate layer and the node H₂₁ of the second intermediate layer are disconnected. That is, the NN 100-2 is an example in which an edge connected to at least one node constituting the NN before compression is partially disconnected. In the example of FIG. 3, the path from the node I₁ to the node H₁₂ and the path from the node H₁₂ to the node H₂₁ are disconnected, but the state in which the node H₁₂ is available is maintained.

As an example of the criteria for disconnecting the edge, the compression unit 21 uses the priority of the edge. The compression unit 21 may disconnect at least one edge included in the NN included in the prediction model based on the priority of the edge. When an edge having a lower priority among the edges connecting the nodes is disconnected, the prediction model can be compressed by reducing the propagation path of the signal in the neural network included in the prediction model without changing the configuration of the nodes. Note that the criteria for disconnecting the edge are not limited to the priority of the edge. For example, an edge with a small weight has a small influence on the output even if it is disconnected. Therefore, for example, the compression unit 21 may disconnect the edge based on the weight of the edge.

The learning device 10 acquires the compression model (first compression model) from the compression unit 21. The learning device 10 acquires learning data from a learning data storage unit (not illustrated). The learning device 10 relearns the learning data for the first compression model.

The determination unit 23 acquires the relearned learning model (second prediction model) from the learning device 11. The determination unit 23 determines whether the second compression model can be further compressed based on whether the second prediction model satisfies a predetermined index related to performance. Further, when it is determined that compression is possible, the compression unit 21 generates a second compression model obtained by compressing the second prediction model. The determination unit 23 determines whether compression is possible by predicting the verification data or the like using the relearned second prediction model. The verification data is sample data prepared separately from the learning data. The determination unit 23 generates a verification result for the verification data. For example, the verification result is a result related to appropriately determined prediction accuracy, a verification result of a feature portion in training data that has contributed to category classification, or the like. The verification result of the feature portion is the degree of deviation of the position of the feature portion that has contributed to the category classification by the second prediction model from the reference position.

The determination unit 23 stores an index for determining the verification result. For example, the index is an allowable value of the prediction accuracy, an allowable value related to a deviation allowable with respect to the reference position of the position of the feature portion that has contributed to the category classification, or the like. The former allowable value is also referred to as a first index, and the latter allowable value is also referred to as a second index. The determination unit 23 compares the verification result with the index. The determination unit 23 determines whether the prediction model can be compressed based on the comparison result between the verification result and the index.

For example, in a case where the verification result satisfies the index, the determination unit 23 determines that the prediction model can be further compressed. In this case, the determination unit 23 instructs the compression unit 21 to repeat the compression of the prediction model. The compression unit 21 further compresses the second prediction model.

For example, in a case where the verification result does not satisfy the index, the determination unit 23 determines that the prediction model cannot be further compressed. That is, the determination unit 23 determines that the compression of the prediction model is completed. In this case, the determination unit 23 outputs a model before being compressed in the compression stage as a learned model.

The compression unit 21 may change the compression amount of the prediction model at a stage of repeating compression. In this case, for example, the compression unit 21 may reduce the compression amount for each compression repetition stage. As a result, since the verification result can be gradually brought close to the first index, it is possible to generate a prediction model that achieves both performance and prediction time. For example, the compression unit 21 can bring the prediction result gradually close to the allowable value by decreasing the compression amount by a predetermined ratio for each compression repetition stage.

The compression unit 21 may change the compression amount of the prediction model according to the difference between the prediction value related to the performance of the prediction model after compression and the allowable value at the stage of repeating the compression. For example, the compression amount at the next stage is increased when there is a margin between the prediction value and the allowable value, and the compression amount at the next stage is decreased when there is no margin between the prediction value and the allowable value. When the compression amount of the prediction model is dynamically changed according to the difference between the prediction value and the allowable value, the compression unit 21 can bring the prediction value gradually close to the allowable value.

### Determination Unit

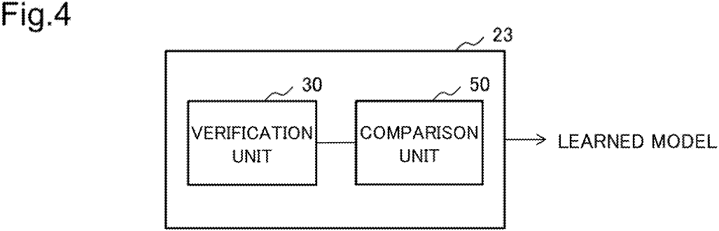

Next, a configuration of the determination unit 23 included in the model compression device 20 will be described with reference to the drawings. FIG. 4 is a block diagram for describing an example of a configuration of the determination unit 23. The determination unit 23 includes a verification unit 30 and a comparison unit 50.

The verification unit 30 verifies the relearned prediction model using the verification data. The verification unit 30 outputs the verification result to the comparison unit 50. The verification result is, for example, a result related to prediction accuracy for prediction of a prediction model using verification data. The verification result may be, for example, a matching rate, a reproduction rate, an F1 value, a score, or the like with respect to the classification of the prediction model using the verification data into a predetermined category.

The verification unit 30 may include, in the verification result, the degree of deviation allowed for the reference position of the position of the feature portion that has contributed to the classification of the verification data. In this case, when classification is performed on the first compression model or the second prediction model using data for verification, the verification unit 30 detects a feature portion that has contributed to the category classification of the verification data. Then, the verification unit 30 detects the degree of deviation of the position of the feature portion that has contributed to the category classification from the reference position as the verification result of the feature portion.

The comparison unit 50 acquires a verification result by the verification unit 30. The comparison unit 50 compares the verification result with a predetermined index. The comparison unit 50 determines whether the generalization performance of the relearned prediction model after compression satisfies a predetermined index according to the comparison result.

For example, the comparison unit 50 compares the result related to the prediction accuracy obtained by the verification of the prediction model with the allowable value (first index) for the result. As a result of the comparison, the comparison unit 50 determines whether the correct answer rate is within an allowable value, that is, whether the performance of the relearned prediction model satisfies a predetermined index and the prediction model can be further compressed.

As another example, for example, the comparison unit 50 compares the position of the feature portion that has contributed to the classification of the verification data with the reference position. The reference position is information indicating a position of a feature portion to be focused on by the prediction model, which is determined in advance with respect to the verification data. Then, the comparison unit 50 determines whether the deviation between the position of the feature portion and the reference position is within an allowable value (second index) related to an allowable deviation of the position of the feature portion with respect to the reference position.

The comparison unit 50 determines whether the compression will be continued or stopped according to the determination result obtained by comparing the verification result with the predetermined index. When the performance of the relearned prediction model satisfies the predetermined index, the determination unit 23 determines that the prediction model can be compressed. In a case where the generalization performance of the relearned prediction model does not satisfy the predetermined index, the comparison unit 50 outputs the prediction model at a time point before compression of the prediction model relearned at that time point as a learned model.

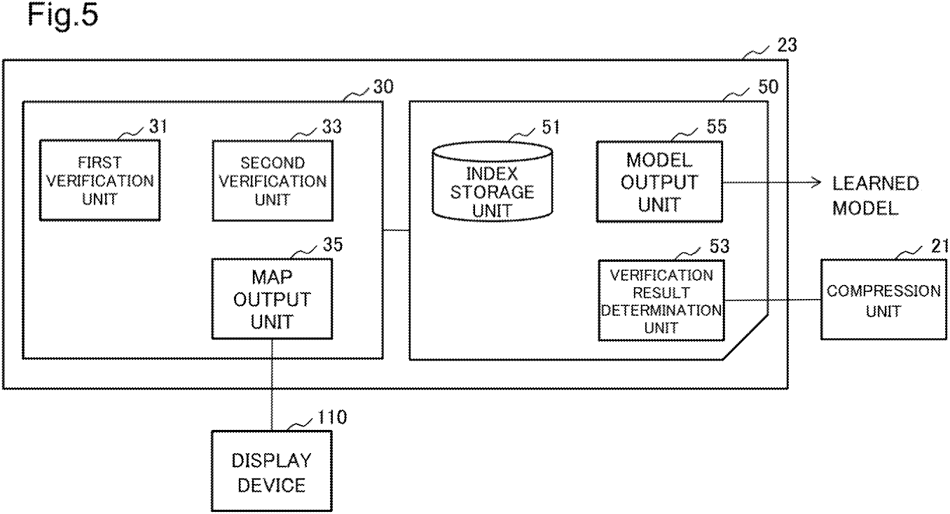

Next, detailed configurations of the verification unit 30 and the comparison unit 50 included in the determination unit 23 will be described with reference to the drawings. FIG. 5 is a block diagram for explaining an example of a detailed configuration of the verification unit 30 and the comparison unit 50. The verification unit 30 includes a first verification unit 31, a second verification unit 33, and a map output unit 35. The comparison unit 50 includes an index storage unit 51, a verification result determination unit 53, and a model output unit 55.

The first verification unit 31 verifies the relearned prediction model using the verification data. The first verification unit 31 outputs the verification result to the verification result determination unit 53 of the comparison unit 50. The verification result is, for example, a result related to prediction accuracy obtained by verification of a prediction model using verification data. The verification result may be, for example, a matching rate, a reproduction rate, an F1 value, a score, or the like obtained by verification of a prediction model using verification data.

When the second verification unit 33 acquires an instruction to generate a visualization map from the verification result determination unit 53, the second verification unit 33 detects a feature portion that has contributed to the category classification of the verification data based on the feature amount that has contributed to the classification of the verification data in the prediction model. For example, when categorizing the verification data, the second verification unit 33 calculates an activation degree indicating the degree of matching with the feature of the category. When the verification data is image data, the second verification unit 33 calculates, as the activation degree, a numerical value related to firing of neurons normalized to a value within a range of 0 or more and 1 or less for each pixel constituting the image data.

The second verification unit 33 may visualize the feature portion detected from the verification data in association with the verification data. In the case of visualization, in a case where the verification data is image data, the second verification unit 33 generates a visualization map that visualizes a feature portion detected from the verification data. The second verification unit 33 outputs, to the verification result determination unit 53, a visualization map that visualizes the feature portion detected using the prediction model generated from the compression model in the current compression stage.

For example, the second verification unit 33 generates a visualization map in which color coding, shading, and tone are set according to the degree of contribution when the verification data is classified into categories. In a case where the verification data is image data, the second verification unit 33 generates a visualization map in which a partial image included in the feature portion detected from the verification data is visualized. In a case where the verification data is text data, the second verification unit 33 generates a visualization map in which words, idioms, and phrases included in the feature portion detected from the verification data are visualized. In a case where the verification data is time-series data, the second verification unit 33 generates a visualization map in which waveforms in a time domain included in the feature portion detected from the verification data are visualized.

For example, the second verification unit 33 generates the visualization map using the method of the Class Activation Map system (method of the CAM system) disclosed in NPLs 1 and 2 below.

NPL 1: R. Selvaraju, et al., “Grad-CAM: Visual Explanations from Deep Networks via Gradient-based Localization”, arXiv: 1610.02391v3 [cs.CV] 21 Mar. 2017.

NPL 2: D. Smilkov, et al., “SmoothGrad: removing noise by adding noise”, arXiv:1706.03825v1 [cs.LG] 12 Jun. 2017.

NPL 1 discloses a method called Grad-CAM, and NPL 2 discloses a method called SmoothGrad.

For example, the second verification unit 33 generates a visualization map using the method of the Attention system disclosed in NPLs 3 and 4 below.

NPL 3: F. Wang, et al., “Residual Attention Network for Image Classification”, arXiv:1704.06904v1 [cs.CV] 23 Apr. 2017.

NPL 4: J. Hu, et al., “Squeeze-and-Excitation Networks”, arXiv: 1709.01507v4 [cs.CV] 16 May 2019.

NPL 3 discloses a method called Residual Attention Network, and NPL 4 discloses a method called Squeeze-and-Excitation Networks.

The map output unit 35 outputs the second visualization map of the verification data verified using the prediction model generated from the compression model of the current compression stage to a display device 110. When the second visualization map is displayed on the screen of the display device 110, the user or the like who looks at the screen can easily visually confirm the performance of the prediction model being compressed. For example, if the visualization maps generated from the prediction models before and after compression are displayed side by side or superimposed on the screen of the display device 110, the performance of the compression model can be easily sensibly grasped. When the visualization map is not displayed on the display device 110, the map output unit 35 may be omitted.

The index storage unit 51 stores an allowable value (first index) for the prediction accuracy obtained by the verification of the prediction model set by the user. For example, the allowable value (first index) is a reference allowed for the reference prediction time of the prediction accuracy allowed for the prediction model. The allowable value (first index) is a reference indicating how much deterioration in prediction accuracy due to compression of the prediction model is allowed. The allowable value (first index) is set by a user who uses the learned model after compression, a business operator who sells the learned model, or the like. The allowable value (first index) may be a threshold value or an allowable range.

The index storage unit 51 may store an allowable value (second index) related to an allowable deviation of the position of the feature portion that has contributed to the category classification with respect to the reference position. For example, the index storage unit 51 stores a visualization map (first visualization map) in which feature portions detected from the verification data using a prediction model in a compression stage before the current compression stage or in a stage of being uncompressed are visualized. The index storage unit 51 stores a determination criterion related to deviation of the visualization map. As an example, the determination criterion is an allowable value (second index) related to a deviation between the first visualization map and the visualization map (second visualization map) in which the feature portion detected from the verification data using the prediction model generated from the compression model in the current compression stage is visualized. The determination criterion may be an allowable value related to a deviation between the reference position determined in advance for the verification data and the second visualization map. The determination criterion related to the deviation between the first visualization map and the second visualization map is set by a user who uses the learned model after compression, a business operator who sells the learned model, or the like. For example, the determination criterion is an area or a ratio of a region where the first visualization map and the second visualization map overlap. For example, the determination criterion is an area or a ratio of a region where the first visualization map and the second visualization map do not overlap. Note that the determination criterion may be appropriately determined according to the needs of the user or the like such as the prediction accuracy and the prediction time of the generated learned model.

For example, the index storage unit 51 compares the first visualization map generated for the prediction model before compression with the second visualization map generated for the prediction model in the current compression stage. For example, the index storage unit 51 compares the first visualization map generated for the prediction model of the compression stage immediately before the current compression stage with the second visualization map generated for the prediction model of the current compression stage. Note that the first visualization map stored in the index storage unit 51 may be in any compression stage as long as it is before the current compression stage. However, when the deterioration of the prediction accuracy is determined based on a certain determination criterion, the first visualization map is preferably the same, and thus, it is preferable to use the prediction model generated from the compression model in the first compression stage or the first visualization map generated for the prediction model before compression.

As an example, the verification result determination unit 53 acquires the verification result from the first verification unit 31 of the verification unit 30. The verification result determination unit 53 compares the verification result with the allowable value (first index) stored in the index storage unit 51. As a result of the comparison, when the verification result is within the allowable range, it is determined that the performance of the relearned prediction model satisfies the predetermined index.

For example, if the validation result is above an allowable value (first index), there is a possibility that the prediction model can be further compressed. In this case, the verification result determination unit 53 transmits an instruction to generate the visualization map to the second verification unit 33. In a case where the visualization map is not generated, the verification result determination unit 53 transmits an instruction to continue the compression to the compression unit 21. In a case where the compression is repeated several times, the prediction model at that stage is compressed as compared with the prediction model before the compression. Therefore, a first threshold value larger than the allowable value (first index) may be set, and when the verification result is below the first threshold value even if the verification result is larger than the allowable value (first index), the prediction model at that stage may be output as the learned model. That is, in a case where the verification result is between the first threshold value and the allowable value, the verification result determination unit 53 may output the prediction model at that stage as a learned model.

When the verification result is below the allowable value (first index), there is a possibility that the prediction accuracy further decreases if the prediction model is further compressed. Therefore, it is difficult to further compress the compression model at the current stage. In this case, the verification result determination unit 53 transmits, to the model output unit 55, an instruction to output a prediction model learned using a compression model in a compression stage immediately before the compression stage. In the case of generating the visualization map at this stage, the verification result determination unit 53 transmits an instruction to generate the visualization map to the second verification unit 33.

Since the prediction model of the current compression stage is more compressed than the prediction model compressed before the current compression stage, the prediction time is likely to be shortened. Therefore, even if the verification result is below the allowable value, if there is no problem in the prediction accuracy, the prediction model in the compression stage may be used as the learned model. Therefore, when the prediction value is below the allowable value, the verification result determination unit 53 may transmit an instruction to output the learned model to the model output unit 55 according to the difference between the verification result and the allowable value (first index). For example, a second threshold value smaller than the verification result and the allowable value (first index) may be set, and if the verification result exceeds the second threshold value even if the verification result is smaller than the allowable value (first index), the learned model at that stage may be output as the prediction model. In the case of generating the visualization map at this stage, the verification result determination unit 53 transmits an instruction to generate the visualization map to the second verification unit 33.

In a case of verifying an allowable deviation of the position of the feature portion that has contributed to the classification of the verification data with respect to the reference position, the verification result determination unit 53 acquires the visualization map (second visualization map) from the second verification unit 33. Upon acquiring the second visualization map, the verification result determination unit 53 acquires the first visualization map from the index storage unit 51. The verification result determination unit 53 compares the first visualization map with the second visualization map, and determines whether the deviation between the visualization maps is within the allowable range based on the determination criterion stored in the index storage unit 51.

In a case where the deviation of the visualization map satisfies the determination criterion, the verification result determination unit 53 determines that the compression model in the compression stage can be further compressed. The compression unit 21 further compresses the compression model according to the determination result. On the other hand, when the deviation of the visualization map does not satisfy the determination criterion, the verification result determination unit 53 transmits, to the model output unit 55, an instruction to output the prediction model generated using the compression model in the compression stage before the compression stage.

When the deviation of the visualization map satisfies the determination criterion, the verification result determination unit 53 may transmit an instruction to output the latest prediction model as the learned model to the model output unit 55 according to the difference between the deviation of the visualization map and the determination criterion. When the compression is repeated several times, the prediction model at that stage is compressed as compared with the prediction model before the compression. Therefore, a first determination criterion larger than the determination criterion of the deviation of the visualization map may be set, and the latest prediction model may be output as the learned model at a stage when the deviation of the visualization map is below the first determination criterion.

In a case where the deviation of the visualization map does not satisfy the determination criterion, if the prediction model is further compressed, the prediction accuracy of the prediction model may be further deteriorated. Therefore, it is difficult to further compress the compression model at the present stage. In this case, the verification result determination unit 53 determines that the compression model at that stage cannot be further compressed. Then, the verification result determination unit 53 transmits an instruction to output the prediction model generated using the compression model compressed in the compression stage immediately before the current compression stage to the model output unit 55.

When the deviation between the first visualization map and the second visualization map does not satisfy the determination criterion, the prediction model generated from the compression model in the current compression stage may be output as the learned model according to the difference between the deviation and the determination criterion. In this case, the verification result determination unit 53 outputs an instruction to output the latest prediction model as the learned model to the model output unit 55. Even if the deviation of the visualization map does not satisfy the determination criterion, if there is no problem in the prediction accuracy, the prediction model generated from the compression model in the current compression stage is more compressed than the prediction model generated from the compression model in the previous compression stage. Therefore, the prediction time of the prediction model generated from the compression model in the current compression stage may be shorter than that of the prediction model generated from the compression model in the previous compression stage. Therefore, a second determination criterion smaller than the determination criterion of the deviation of the visualization map may be set, and when the deviation of the visualization map is not below the second determination criterion, the prediction model generated from the compression model in the current compression stage may be output as the learned model.

When outputting the visualization map, the verification result determination unit 53 transmits the first visualization map generated from the prediction model and the second visualization map generated from the compression model at the current stage to the map output unit 35. For example, when the deviation between the first visualization map and the second visualization map does not satisfy the determination criterion, the verification result determination unit 53 transmits an instruction to output these visualization maps to the map output unit 35. For example, every time the first visualization map and the second visualization map are generated, the verification result determination unit 53 may transmit an instruction to output these visualization maps to the map output unit 35.

Upon acquiring an instruction to output the learned model from the verification result determination unit 53, the model output unit 55 outputs the prediction model in the compression stage or a previous compression stage as the learned model. When the first threshold or the second threshold is not set, the model output unit 55 outputs the prediction model in the compression stage immediately preceding the compression stage as a learned model. When the first threshold and the second threshold are set, the model output unit 55 outputs the prediction model in the compression stage as a learned model.

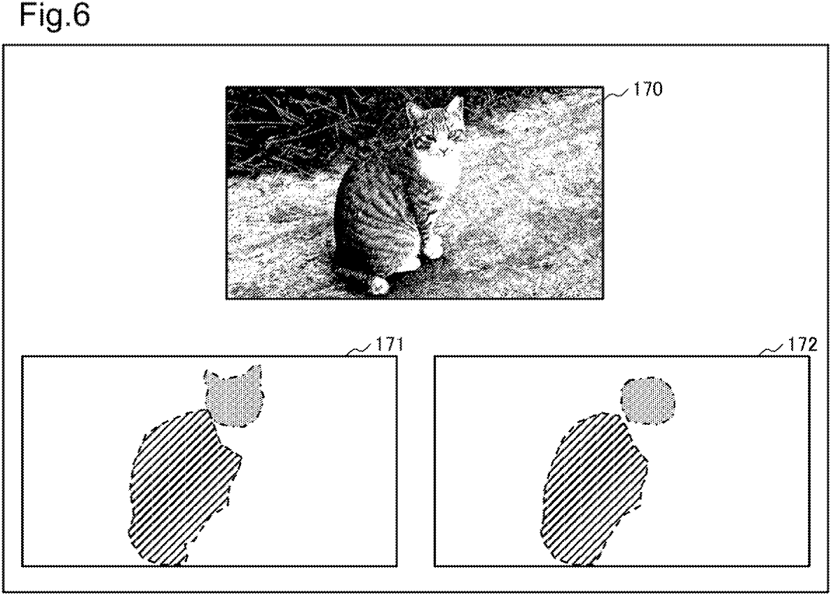

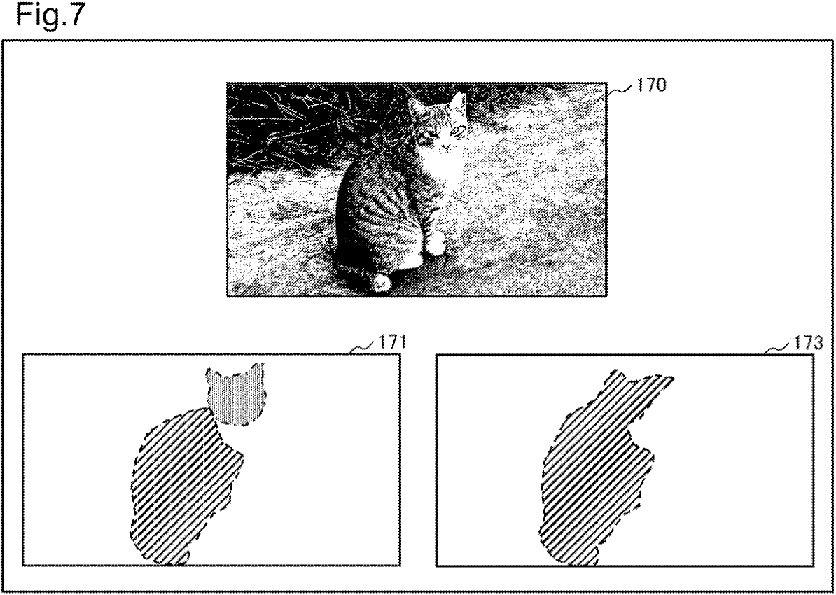

FIGS. 6 and 7 are conceptual diagrams illustrating an example of a visualization map generated by the second verification unit 33 in an example of predicting whether a cat (correct answer) is included in image data. In the examples of FIGS. 6 and 7, an example is illustrated in which the image data 170 including a cat is used as input data, and the visualization map is generated using the prediction model before compression and the prediction model after compression. Note that FIGS. 6 and 7 are diagrams conceptually illustrating examples of the visualization map generated by the second verification unit 33.

FIG. 6 is an example in which a first visualization map 171 generated from a prediction model before compression and a second visualization map 173 generated from a compression model after compression are illustrated side by side under the image data 170 including a cat. The first visualization map 171 and the second visualization map 173 include a region (within the range of a one-dot chain line) from which a feature of a cat’s face is extracted and a region (within the range of a broken line) from which a feature of a cat is extracted. In the first visualization map 171, a cat’s face including a cat’s ear is extracted. On the other hand, in the second visualization map 173, the cat’s ear is not extracted, but the cat’s face is extracted. In a case where the cat (correct answer) can be detected if the cat's face and pattern are extracted, the deviation between the first visualization map 171 and the second visualization map 173 is within the allowable range. On the other hand, in a case where it is not determined that the cat’s face has been extracted unless the cat’s ears have been extracted, the deviation between the first visualization map 171 and the second visualization map 173 is out of the allowable range.

FIG. 7 is an example in which a first visualization map 171 generated from a prediction model before compression and a second visualization map 173 generated from a compression model after compression are illustrated side by side under image data 170 including a cat. The first visualization map 171 includes a region visualizing the features of the cat’s face (within the range of a one-dot chain line) and a region visualizing the cat’s pattern (within the range of a broken line). On the other hand, in the second visualization map 173, the cat pattern is extracted, but the cat face is not extracted. In a case where the cat (correct answer) can be detected if the cat’s face and pattern are extracted, the deviation between the first visualization map 171 and the second visualization map 173 is out of the allowable range. In a case where it is determined that a cat has been detected as long as the cat’s pattern is extracted, the deviation between the first visualization map 171 and the second visualization map 173 is within an allowable range.

As illustrated in FIGS. 6 and 7, a range set by a user or the like is used as an allowable range for the deviation between the first visualization map 171 and the second visualization map 173. Therefore, if the prediction model is compressed based on the allowable range set by the user or the like, a learned model in which the prediction accuracy and the prediction time satisfy the needs of the user or the like can be generated. If the visualization maps generated from the prediction models before and after compression are displayed on the screen of the display device 110, it is easy to sensibly grasp the compression state. Note that the display device 110 may display the visualization map together with the image data 170 as illustrated in FIGS. 6 and 7, or may display only the visualization map.

### Operation

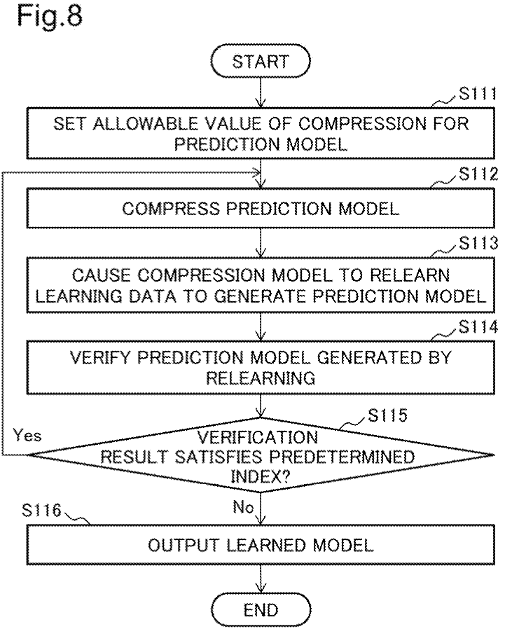

Next, an operation of the learning system 1 of the present example embodiment will be described with reference to the drawings. FIG. 8 is a flowchart for explaining the operation of the learning system 1.

In FIG. 8, first, the learning system 1 receives setting of an allowable value of compression for the prediction model (step S111). At this time, the learning system 1 receives an allowable value of compression input via an input device (not illustrated) used by a user or the like, and sets the allowable value. For example, the allowable value of compression for the prediction model is set by a business operator who sells a learned model generated based on the prediction model, a user who uses the learned model, or the like.

Next, the compression unit 21 of the model compression device 20 compresses the prediction model (step S112).

Next, the learning device 10 generates a prediction model by causing the compression model compressed by the compression unit 21 to relearn learning data (step S113).

Next, the determination unit 23 of the model compression device 20 inputs the verification data to the prediction model generated by the learning device 10 and verifies the prediction model (step S114).

Here, the determination unit 23 of the model compression device 20 determines whether the prediction model can be further compressed based on whether the verification result satisfies a predetermined index (step S115).

When the determination unit 23 of the model compression device 20 determines that the verification result satisfies the predetermined index and the prediction model can be further compressed (Yes in step S115), the process returns to step S112 and the compression of the prediction model is continued. On the other hand, when it is determined that the verification result does not satisfy the predetermined index and the prediction model cannot be further compressed (No in step S115), the determination unit 23 outputs the prediction model generated from the compression model in the compression stage as a learned model (step S116).

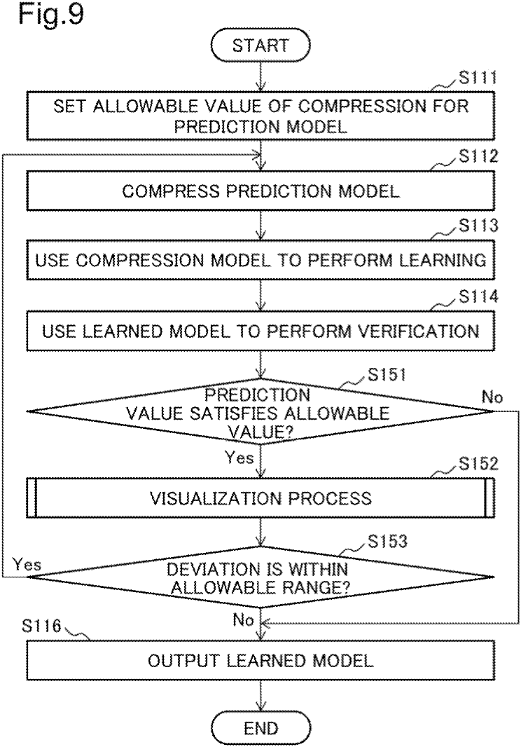

Next, an example in which a process of determining prediction accuracy (determination process) and a process of generating a visualization map (visualization process) are performed in the process of step S115 of the flowchart of FIG. 8 will be described with reference to the drawings. FIG. 9 is a flowchart in a case where determination processing and visualization processing are performed. Further, steps S111 to S114 and step S116 in FIG. 9 are similar to steps S111 to S114 and step S116 in FIG. 8, and thus description thereof is omitted.

After step S114 in FIG. 9, the determination unit 23 of the model compression device 20 determines whether the prediction value included in the verification result satisfies the allowable value (step S151). When the prediction value included in the verification result satisfies the allowable value (Yes in step S151), the determination unit 23 generates the visualization map (step S152). On the other hand, when the prediction value included in the verification result does not satisfy the allowable value (No in step S151), the prediction model generated from the compression model in the compression stage is output as the learned model (step S116).

After the visualization processing in step S152, the determination unit 23 of the model compression device 20 determines whether the deviation of the visualization map is within the allowable range (step S153). When the deviation of the visualization map is within the allowable range (Yes in step S153), the process returns to step S112 and the compression of the prediction model is continued. On the other hand, when the deviation of the visualization map is out of the allowable range (No in step S153), the determination unit 23 outputs the prediction model generated from the compression model in the compression stage as a learned model (step S116).

Note that the processing of the learning system 1 of the present example embodiment may be performed in a form different from the flowchart illustrated in FIG. 9. For example, step S151 may be executed after step S153. For example, the visualization process (step S152) and the comparison of the deviation of the visualization map (step S153) may be omitted. For example, the visualization map generated in the visualization process (step S152) may be displayed on the display device 110.

As described above, the learning system of the present example embodiment includes the model compression device and the learning device. The model compression device includes a compression unit and a verification unit. The compression unit compresses a first prediction model generated by machine learning in the learning device to generate a first compression model, and causes the learning device to perform relearning with the first compression model. The determination unit determines whether the second prediction model generated by machine learning satisfies a predetermined index related to generalization performance, and when the predetermined index is satisfied, the compression unit compresses the second prediction model to generate a second compression model. The learning device generates the first prediction model and the second prediction model by executing machine learning on the first compression model and the second compression model, respectively, compressed by the model compression device.

In an aspect of the present example embodiment, the compression unit repeats a process of compressing the second prediction model to generate the second compression model and executing relearning while the determination unit determines that the prediction model can be further compressed.

In an aspect of the present example embodiment, the determination unit determines whether the second prediction model generated by machine learning satisfies a first index related to the prediction accuracy or a second index related to the feature portion that has contributed to the classification of the second prediction model. The determination unit determines that the second prediction model can be further compressed.

In an aspect of the present example embodiment, the second index is an allowable value related to an allowable deviation with respect to the position of the feature portion. When verifying the first compression model or the second prediction model by executing machine learning using the verification data, the determination unit detects a feature portion that has contributed to category classification of the verification data. In a case where the deviation with respect to the position of the feature portion is within the allowable value, the determination unit causes the compression unit to repeat the compression of the second compression model.

In an aspect of the present example embodiment, in a case where the allowable deviation with respect to the position of the feature portion exceeds the allowable value, the determination unit causes the second prediction model compressed in any compression stage by the compression unit to be output as the learned model.

In an aspect of the present example embodiment, the determination unit generates a visualization map visualizing a feature portion, and displays the visualization map on a screen of a display device in association with data for verification.

In an aspect of the present example embodiment, the compression unit changes compression of the second prediction model. For example, the compression unit changes the compression amount of the second prediction model at a stage where the determination unit causes the compression unit to repeat the process of compressing the second prediction model to generate the second compression model and executing relearning until a predetermined index related to generalization performance is not satisfied.

In an aspect of the present example embodiment, the compression unit compresses the first prediction model and the second prediction model by disconnecting any one of edges included in at least one edge. For example, the compression unit determines an edge to be disconnected based on a priority set to at least one edge connecting a plurality of nodes constituting a neural network included in the first prediction model and the second prediction model.

The learning system of the present example embodiment is provided with a process of causing a user to designate a setting value as to how much deterioration in prediction accuracy is allowed, and stopping model compression in a case where the prediction accuracy is significantly lowered. Therefore, according to the learning system of the present example embodiment, it is possible to efficiently generate a prediction model whose prediction time is shortened while ensuring adequate performance required for machine learning.

### Second Example Embodiment

Next, a model compression device according to a second example embodiment will be described with reference to the drawings. The model compression device according to the present example embodiment compresses a prediction model including a neural network (hereinafter, referred to as NN). Compression of the prediction model is performed for the purpose of shortening a prediction time by the prediction model. The index related to the performance of the prediction model is specified by the user with respect to how much deterioration in prediction accuracy is allowed.

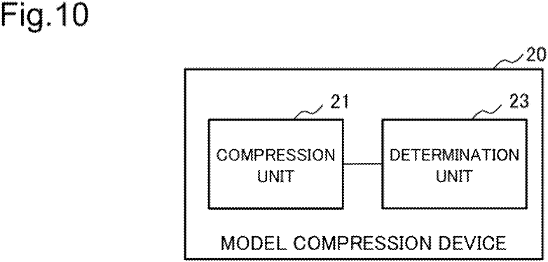

FIG. 10 is a block diagram illustrating an example of a configuration of the model compression device 20 of the present example embodiment. As illustrated in FIG. 10, the model compression device 20 includes a compression unit 21 and a determination unit 23. The model compression device 20 corresponds to the model compression device 20 of the first example embodiment. Details of the model compression device 20 are as described in the first example embodiment.

The compression unit 21 generates a compression model obtained by compressing the first prediction model generated by machine learning.

The determination unit 23 determines whether the second prediction model can be further compressed based on the index related to the performance of the second prediction model generated by relearning the compression model.

According to the model compression device of the present example embodiment, it is possible to efficiently generate a prediction model whose prediction time is shortened while ensuring adequate performance required for machine learning.

### Hardware

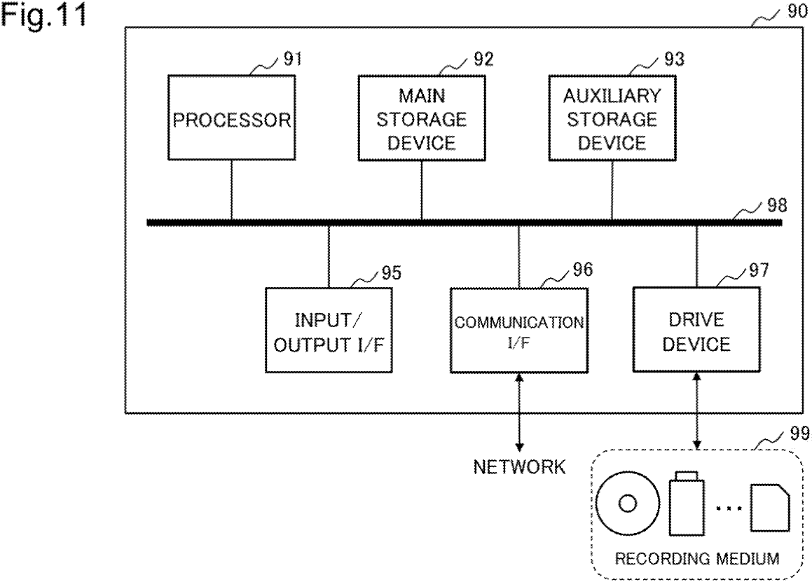

Here, a hardware configuration for achieving the learning system (including the model compression device according to the second example embodiment) according to the first example embodiment will be described using an information processing apparatus 90 of FIG. 11 as an example.

As illustrated in FIG. 11, the information processing apparatus 90 includes a processor 91, a main storage device 92, an auxiliary storage device 93, an input/output interface 95, a communication interface 96, and a drive device 97. In FIG. 11, the interface is abbreviated as an interface (I/F). The processor 91, the main storage device 92, the auxiliary storage device 93, the input/output interface 95, the communication interface 96, and the drive device 97 are data-communicably connected to each other via a bus 98. The processor 91, the main storage device 92, the auxiliary storage device 93, and the input/output interface 95 are connected to a network such as the Internet or an intranet via the communication interface 96. In addition, FIG. 11 illustrates a recording medium 99 capable of recording data.

The processor 91 deploys the program stored in the auxiliary storage device 93 or the like in the main storage device 92 and executes the deployed program. In the present example embodiment, a software program installed in the information processing apparatus 90 may be used. The processor 91 executes processing by the learning system according to the present example embodiment.

The main storage device 92 has an area in which a program is deployed. The main storage device 92 may be a volatile memory such as a dynamic random access memory (DRAM).

The auxiliary storage device 93 stores various types of data. The auxiliary storage device 93 includes a local disk such as a hard disk or a flash memory.

The input/output interface 95 is an interface for connecting the information processing apparatus 90 and a peripheral device. The communication interface 96 is an interface for connecting to an external system or device through a network such as the Internet or an intranet based on a standard or a specification. The input/output interface 95 and the communication interface 96 may be shared as an interface connected to an external device.

An input device such as a keyboard, a mouse, or a touch panel may be connected to the information processing apparatus 90 as necessary. These input devices are used to input information and settings. When the touch panel is used as the input device, the display screen of the display device may also serve as the interface of the input device. Data communication between the processor 91 and the input device may be mediated by the input/output interface 95.

The information processing apparatus 90 may be provided with a display device for displaying information. In a case where a display device is provided, the information processing apparatus 90 preferably includes a display control device (not illustrated) for controlling display of the display device. The display device may be connected to the information processing apparatus 90 via the input/output interface 95.

The drive device 97 is connected to the bus 98. The drive device 97 mediates reading of data and a program from the recording medium 99, writing of a processing result of the information processing apparatus 90 to the recording medium 99, and the like between the processor 91 and the recording medium 99 (program recording medium). When the recording medium 99 is not used, the drive device 97 may be omitted.

The recording medium 99 can be achieved by, for example, an optical recording medium such as a compact disc (CD) or a digital versatile disc (DVD). The recording medium 99 may be achieved by a semiconductor recording medium such as a universal serial bus (USB) memory or a secure digital (SD) card, a magnetic recording medium such as a flexible disk, or another recording medium. In a case where the program executed by the processor is recorded in the recording medium 99, the recording medium 99 corresponds to a program recording medium.

Note that the hardware configuration of FIG. 11 is an example of a hardware configuration for executing the arithmetic processing of the learning system according to the present example embodiment, and the arithmetic processing of the learning system may be executed by hardware having a configuration different from this. In addition, a program for causing a computer to execute processing related to the learning system according to the present example embodiment is also included in the scope of the present invention. Further, a program recording medium in which the program according to the present example embodiment is recorded is also included in the scope of the present invention.

The components of the learning system of the present example embodiment can be arbitrarily combined. The components of the learning system of the present example embodiment may be configured by single hardware or may be configured by different hardware. For example, the components of the learning system of the present example embodiment are configured in a dedicated application server. For example, the components of the learning system of the present example embodiment are distributed and arranged in a plurality of different servers. The components of the learning system of the present example embodiment may be implemented by software or may be implemented by a circuit.

Although the present invention has been described with reference to the example embodiments, the present invention is not limited to the above example embodiments. Various modifications that can be understood by those skilled in the art can be made to the configuration and details of the present invention within the scope of the present invention.

Some or all of the above example embodiments may be described as the following supplementary notes, but are not limited to the following.

### Supplementary Note 1

A model compression device including:
a compression unit that generates a compression model obtained by compressing a first prediction model generated by machine learning; and
a determination unit that determines whether the second prediction model can be further compressed based on an index related to performance of the second prediction model generated by relearning the compression model.

### Supplementary Note 2

The model compression device according to Supplementary Note 1, wherein the compression unit generates a second compression model obtained by compressing the second prediction model when it is determined that the second prediction model can be further compressed.

### Supplementary Note 3

The model compression device according to Supplementary Note 2, wherein the compression unit repeats generation of the second compression model obtained by compressing the second prediction model while the determination unit determines that further compression is possible.

### Supplementary Note 4

The model compression device according to Supplementary Note 3, wherein the compression unit changes a compression amount of the second prediction model in each case of repeating generation of the second compression model.

### Supplementary Note 5

The model compression device according to any one of Supplementary Notes 1 to 4, wherein the determination unit selects a prediction model at any stage before compressing the second prediction model as a learned model when it is determined that the second prediction model cannot be further compressed.

### Supplementary Note 6

The model compression device according to any one of Supplementary Notes 1 to 5, wherein the determination unit determines whether the second prediction model can be further compressed based on at least one of a first index related to prediction accuracy of the second prediction model or a second index related to a feature portion that has contributed to classification of data by the second prediction model.

### Supplementary Note 7

The model compression device according to Supplementary Note 6, wherein the second index is a degree of deviation of the feature portion from a reference in the data.

### Supplementary Note 8

The model compression device according to Supplementary Note 6 or 7, wherein the determination unit generates a visualization map visualizing the feature portion, and outputs the visualization map to a display device in association with the data.

### Supplementary Note 9

The model compression device according to any one of Supplementary Notes 1 to 8, wherein the compression unit compresses the first prediction model and the second prediction model by disconnecting any one of edges included in at least one edge connecting a plurality of nodes constituting a neural network included in the first prediction model and the second prediction model based on a priority set to the at least one edge.

### Supplementary Note 10

A learning system including:
the model compression device according to any one of Supplementary Notes 1 to 9, and
a learning device that generates the second prediction model by machine learning with respect to the compression model compressed by the model compression device.

### Supplementary Note 11

A model compression method, executed by a computer, including:
by a computer,
compressing a first prediction model generated by machine learning in a learning device to generate a first compression model;
performing relearning on the learning device in the first compression model;
determining whether a second prediction model generated by the machine learning satisfies a predetermined index related to generalization performance; and
compressing the second prediction model to generate a second compression model when the predetermined index is satisfied.

### Supplementary Note 12

A program for causing a computer to execute processes of:
compressing a first prediction model generated by machine learning in a learning device to generate a first compression model;
performing relearning on the learning device in the first compression model;
determining whether a second prediction model generated by the machine learning satisfies a predetermined index related to generalization performance; and
compressing the second prediction model to generate a second compression model when the predetermined index is satisfied.

### REFERENCE SIGNS LIST

1 Learning system
10 Learning device
20 Model compression device
21 Compression unit
23 Determination unit
30 Verification unit
50 Comparison unit
31 First verification unit
33 Second verification unit
35 Map output unit
51 Index storage unit
53 Verification result determination unit
55 Model output unit
110 Display device

What is claimed is:

1. A model compression device comprising:
at least one memory storing instructions: and
at least one processor configured to access the at least one memory and execute the instructions to:
generate a compression model obtained by compressing a first prediction model generated by machine learning; and
determine whether a second prediction model can be further compressed based on an index related to performance of the second prediction model generated by relearning the compression model.

2. The model compression device according to claim 1, wherein
the at least one processor is further configured to execute the instructions to:
generate a second compression model obtained by compressing the second prediction model when it is determined that the second prediction model can be further compressed.

3. The model compression device according to claim 2, wherein
the at least one processor is further configured to execute the instructions to:
repeat generation of the second compression model obtained by compressing the second prediction model while the determination means determines that further compression is possible.

4. The model compression device according to claim 3, wherein
the at least one processor is further configured to execute the instructions to:
change a compression amount of the second prediction model in each case of repeating generation of the second compression model.

5. The model compression device according to claim 1, wherein
the at least one processor is further configured to execute the instructions to:
select a prediction model at any stage before compressing the second prediction model as a learned model when it is determined that the second prediction model cannot be further compressed.

6. The model compression device according to claim 1, wherein
the at least one processor is further configured to execute the instructions to:
determine whether the second prediction model can be further compressed based on at least one of a first index related to prediction accuracy of the second prediction model or a second index related to a feature portion that has contributed to classification of data by the second prediction model.

7. The model compression device according to claim 6, wherein
the second index is a degree of deviation of the feature portion from a reference in the data.

8. The model compression device according to claim 6, wherein
the at least one processor is further configured to execute the instructions to:
generate a visualization map visualizing the feature portion, and outputs the visualization map to a display device in association with the data.

9. The model compression device according to claim 1, wherein
the at least one processor is further configured to execute the instructions to:
compress the first prediction model and the second prediction model by disconnecting any one of edges included in at least one edge connecting a plurality of nodes constituting a neural network included in the first prediction model and the second prediction model based on a priority set to the at least one edge.

10.
The model compression device according to claim 1, wherein
the at least one processor is further configured to execute the instructions to:
generate the second prediction model by machine learning with respect to the compression model compressed by the model compression device.

11. A model compression method, executed by a computer, comprising:
compressing a first prediction model generated by machine learning in a learning device to generate a first compression model;
performing relearning on the learning device in the first compression model;
determining whether a second prediction model generated by the machine learning satisfies a predetermined index related to generalization performance; and
compressing the second prediction model to generate a second compression model when the predetermined index is satisfied.

12. A non-transitory program recording medium storing program for causing a computer to execute processes of:
compressing a first prediction model generated by machine learning in a learning device to generate a first compression model;
performing relearning on the learning device in the first compression model;
determining whether a second prediction model generated by the machine learning satisfies a predetermined index related to generalization performance; and
compressing the second prediction model to generate a second compression model when the predetermined index is satisfied.
